(19) United States
(12) Patent Application Publication
(10) Pub. No.: US 2011/0095049 A1
(43) Pub. Date: Apr. 28, 2011

(54) Dosing Device

(76) Inventor: Heinz-Dieter Eichholz, Isterlohn (DE)

(21) Appl. No.: 12/981,624

(22) Filed: Dec. 30, 2010

Related U.S. Application Data
(63) Continuation of application No. PCT/DE2009/000929, filed on Jul. 1, 2009.

(30) Foreign Application Priority Data
Jul. 2, 2008 (DE) 10 2008 030 923.0

(51) Int. Cl. B67D 7/08; B67D 7/14

(52) U.S. Cl. 222/23; 222/52; 222/135

(57) ABSTRACT

Device for dosing liquid detergents or rinsing agents in dishwashers and/or washing machines. The device includes at least one chamber for storing the detergents or rinsing agents and a replaceable unit. At least two units of quantity are stored in the respective chamber, one unit of quantity representing the quantity of detergent or rinsing agent required for one washing cycle and stored in the respective chamber. In order to be able to easily recycle the replaceable unit of the dosing device, a control unit is provided for emptying the rest of detergent or rinsing agent from at least one chamber.

### CROSS REFERENCE TO RELATED APPLICATIONS

The present application is a continuation of International Patent Application No. PCT/DE2009/000929 filed 1 Jul. 2009, which claims priority to German Patent Application No. 10 2008 030 923.0 filed 2 Jul. 2008, both of which are incorporated herein by reference.

The invention relates to a dispensing device for dispensing liquid cleaning or rinsing agents in dishwashers and/or washing machines and having at least one chamber for storing the cleaning or rinsing agent.

Dispensing devices are already known from the prior art, such as from documents WO 02/077353 A1 and DE 10 2006 024 152 A1.

The present invention provides a dispensing device having a readily disposable replacement unit.

Considering a dispensing device of the above-stated type, the dispensing device of the present invention includes at least one chamber for storing the cleaning or rinsing agent, wherein the at least one chamber forms a replacement unit. The at least one chamber is able to store at least two quantity units of the cleaning or rinsing agent, wherein one quantity unit represents the amount of cleaning or rinsing agent required for a respective washing cycle. The dispensing device further includes a control unit for residual emptying of the at least one chamber.

Advantageous exemplary embodiments and further developments of the invention are possible thanks to features further stated herein. These include a filling level sensor for determining the filling level of at least one chamber, an outlet device actuatable by the control unit, a cartridge containing the at least one chamber, an energy source or supply unit, a bracket and a light-emitting diode.

In one aspect a dispensing device according to the invention contains a control unit for emptying at least one chamber of residues. In a further aspect the device includes a plurality of chambers for storing different cleaning or rinsing agents for dispensing. Typically, the amount or quantity units of a rinsing or cleaning agent required for different cleaning or rinsing agents during a washing cycle do not correspond to one another. Although the volume of the respective chambers can be configured so that individual cleaning or rinsing agents are approximately sufficient for an identical number of washing cycles, there may be instances when a residue of the corresponding cleaning or rinsing agent still remains in one or more chambers, while another chamber has already been completely emptied.

With the presence of a control unit which permits the emptying of chambers of their residues, the consumer can relatively straightforwardly dispose of the replacement unit. Moreover, the dispensing device can also be configured in a more environmentally friendly manner, as the consumer no longer has to bother with disposing of any residual amounts of cleaning and rinsing agent together with or separately from the replacement unit.

### BRIEF DESCRIPTION OF THE DRAWINGS

The drawing shows an exemplary embodiment of the invention and is explained in greater detail below with reference to the FIGURE. Specifically—

FIG. 1 is a schematic diagram of a dispensing device with a control unit for residual emptying.

### DETAILED DESCRIPTION

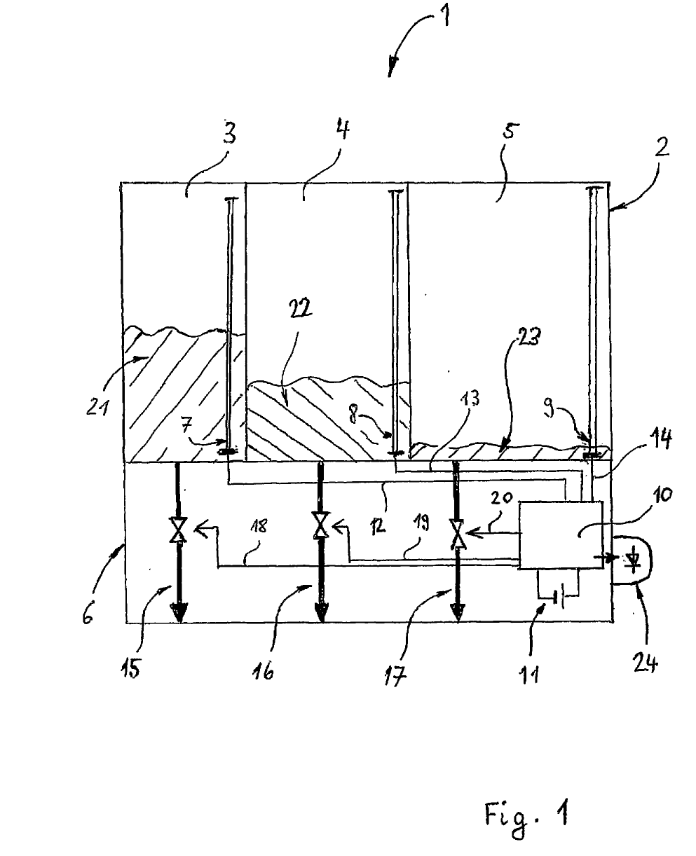

FIG. 1 shows one embodiment of a dispensing device 1 according to the present invention having a cartridge 2 as replacement unit and a bracket 6. The cartridge 2 and bracket 6 can be separated by a user. The cartridge 2 includes individual chambers 3, 4 and 5 in which cleaning and/or rinsing agents 21, 22, 23 can be stored. Filling level sensors 7, 8, 9 can also be located in the chambers 3, 4, 5.

The filling level sensors 7, 8, 9 are connected to a control unit 10 via connecting leads 12, 13, 14. Energy can be supplied to the control unit 10 by an energy source such as a battery 11. Outlet devices or actuators 15, 16, 17 can also be provided for dispensing from and/or emptying the chambers 3, 4, 5. In the present exemplary embodiment, the chambers 3, 4, 5 are emptied downwards in the direction of gravity. The outlet devices 15, 16, 17 are controlled by the control unit 10 via control leads 18, 19, 20.

A light-emitting diode (LED) 24, also actuated by the control unit 10, can be mounted on the bracket 6. In the event that the cartridge is separated from the bracket 6, the control unit 10 can cause the LED 24 to light up or flash. For example, a green illuminated LED can mean that a consumer can reconnect the cartridge 2 to the bracket 6 and continue to use the cartridge 2. Should the light-emitting diode 24 flash red, this can mean that the cartridge can be used for only one more washing cycle, after which it must be disposed of. This can also means that the chambers 3, 4, 5 will be emptied of any residue during the next washing cycle.

The exemplary embodiment shown here is designed so that as soon as one chamber is empty, or less than one quantity unit required for a washing cycle is present in one of the chambers, the entire system (i.e., all the chambers 3, 4 and 5) is emptied completely.

In order to make the bracket 6 very easy to dispose of, a predetermined breaking point can be provided for breaking up the bracket 6 and removing the battery 11, thereby enabling segregated, environmentally friendly disposal of bracket 6 and battery 11 and facilitating this for the consumer.

A feature common to all exemplary embodiments and further developments of the invention is that a control unit is provided for emptying at least one chamber of residues.

### LIST OF REFERENCE NUMERALS

1 Dispensing device
2 Cartridge
3 Chamber
4 Chamber
5 Chamber
6 Bracket
7 Filling level sensor
8 Filling level sensor
9 Filling level sensor
10 Control unit
11 Battery
12 Connecting lead
13 Connecting lead
14 Connecting lead
15 Outlet device/actuator
16 Outlet device/actuator
17 Outlet device/actuator
18 Control lead
19 Control lead
20 Control lead
21 Cleaning/rinsing agent
22 Cleaning/rinsing agent
23 Cleaning/rinsing agent
24 LED

We claim:

1. Dispensing device for dispensing liquid cleaning or rinsing agent in dishwashers and/or washing machines comprising:
a replacement unit having at least one chamber for storing the cleaning or rinsing agent, wherein the at least one chamber is able to store at least two quantity units, one quantity unit representing an amount of cleaning or rinsing agent required for a respective washing cycle, and
a control unit for residual emptying of at least one chamber.

2. Dispensing device according to claim 1 further comprising a filling level sensor for determining the filling level of the at least one chamber.

3. Dispensing device according to claim 2, wherein the control unit is able to detect signals from the filling level sensor and empty at least one chamber when the filling level sensor detects a filling level which is less than one quantity unit in the chamber or one of the chambers.

4. Dispensing device according to claim 1, wherein the control unit is able to empty the chambers of the replacement unit when one chamber contains less than one quantity unit of cleaning or rinsing agent.

5. Dispensing device according to claim 1 further comprising an outlet device actuatable by the control unit.

6. Dispensing device according to claim 5, wherein the control unit is able to output one quantity unit by means of the outlet device.

7. Dispensing device according to claim 5, wherein the control unit is configured to empty all chambers by clocked output of quantity units of substantially all of the cleaning or rinsing agent present in the respective chamber by means of the outlet device.

8. Dispensing device according to claim 5, wherein the control unit is configured to empty all chambers by a single output all at once of substantially all of the cleaning or rinsing agent present in the respective chamber by means of the outlet device.

9. Dispensing device according to claim 1 further comprising a cartridge containing the chambers.

10. Dispensing device according to claim 1 further comprising a bracket containing the control unit and/or the outlet device.

11. Dispensing device according to claim 10, wherein the cartridge and/or bracket are configured as a replaceable replacement unit.

12. Dispensing device according to claim 1 further comprising an energy supply unit.

13. Dispensing device according to claim 12, wherein the energy supply unit is mounted in an interior of a bracket.

14. Dispensing device according to claim 12, wherein the energy supply unit is a battery.

15. Dispensing device according to claim 10, wherein the bracket further comprises a predetermined breaking point for breaking open the bracket and removing a battery.

16. Dispensing device according to claim 1 further comprising a cartridge containing closing devices which, when operationally connected with a bracket, are no longer closable.

17. Dispensing device according to claim 1 further comprising a light-emitting diode for displaying usage status.

18. Dispensing device according to claim 1 further comprising a transparent viewing window for viewing the filling level.
